(19) United States
(12) Patent Application Publication
(10) Pub. No.: US 2005/0135790 A1
(43) Pub. Date: Jun. 23, 2005

(54) Digital media player with resolution adjustment capabilities

(75) Inventor: Matthijs Hutten, Redwood City, CA (US)

Correspondence Address: BEYER WEAVER & THOMAS LLP, P.O. BOX 70250, OAKLAND, CA, 94612-0250, US

(73) Assignee: SanDisk Corporation

(21) Appl. No.: 10/745,910

(22) Filed: Dec. 23, 2003

(51) Int. Cl. H04N 5/781

(52) U.S. Cl. 386/125

(57) ABSTRACT

A digital media player is disclosed. The digital media player can permit one or a group of users to play digital media in a convenient and user-friendly manner. Typically, a memory card stores the digital media to be played by the digital media player. After the memory card is coupled to the digital media player, the digital media player can operate to play (e.g., view) or manipulate (e.g., zoom, rotate, delete, etc.) digital media. The digital media player can also operate to archive the digital media in a reduced resolution format. The reduced resolution format is adequate for an intended output device, yet has a substantially reduced file size.

### BACKGROUND OF THE INVENTION

1. Field of the Invention

The present invention relates to media presentation and, more particularly, to media presentation facilitated by storage of media on memory cards.

2. Description of the Related Art

Memory cards are removable data storage devices that are highly portable due to their relatively small form factor. Memory cards are commonly used to store digital data for use with various products (e.g., electronics products) such as cameras, hand-held computers, set-top boxes, hand-held or other small audio players/recorders (e.g., MP3 devices), and medical monitors. Examples of memory cards are flash cards that use Flash type or EEPROM type memory cells to store the data. A major supplier of flash cards is SanDisk Corporation of Sunnyvale, Calif.

Cameras are used to capture images (i.e., digital photos) of scenes and people of interest to a user. In recent years, digital cameras have become popular. Advances in camera technology has led to ever increasing resolution capabilities for cameras. For example, many cameras today can provide upwards of 3.1 megapixels or more of resolution. The digital photos acquired by such cameras are normally stored to memory cards. Today, the capacity of such memory cards is often 128 or 256 Megabytes (MB). Unfortunately, however, as resolutions increase, file size increases. For images captured with a 3.1 megapixel camera, the file size is upwards of 1 MB or more. As a result, the usefulness of memory cards is limited because they are unable to store a large number of digital photos.

In addition, displaying digital photos so that they can be viewed by a group of people is often not able to be achieved in a user-friendly manner. For example, to use a television to view digital photos taken by a digital camera, the camera has to be connected to video input terminals of a television. The required connections and equipment needed to view digital photos in this manner makes viewing photos on a television cumbersome.

Thus, there is a need to facilitate the storage of larger numbers of digital photos on a memory card. There is also a need for improved approaches to facilitating sharing of digital photos.

### SUMMARY OF THE INVENTION

Broadly speaking, the invention pertains to a digital media player. The digital media player can permit one or a group of users to play digital media in a convenient and user-friendly manner. Typically, a memory card stores the digital media to be played by the digital media player. After the memory card is coupled to the digital media player, the digital media player can operate to play (e.g., view) or manipulate (e.g., zoom, rotate, delete, etc.) the digital media. The digital media player can also operate to archive digital media in a reduced resolution format. The reduced resolution format is adequate for an intended output device, yet has a substantially reduced file size.

The invention can be implemented in numerous ways, including as a system, apparatus, device, method or computer readable medium. Several embodiments of the invention are discussed below.

As a digital media viewer, one embodiment of the invention includes at least: a housing having a plurality of slots for receiving at least one removable storage card, and a processor. The at least one removable storage card stores digital media items. The processor accesses the digital media items from the at least one removable storage card, modifies the digital media items to have a reduced resolution format, and stores the modified digital media items having the reduced resolution format to the at least one removable storage card or another storage card.

As a digital media player, one embodiment of the invention includes at least: a housing having a plurality of slots for receiving at least one removable storage card, and a processor. The at least one removable storage card stores digital media items. The processor accesses the digital media items from the at least one removable storage card, and produces output signals for presenting the digital media items to one or more interested persons.

As a method for reducing resolution of media items to be commensurate with a display device for viewing media items, one embodiment of the invention includes at least: reading high resolution media files from a first removable media storage card, the first removable data storage card having the high resolution media files pertaining to media items stored thereon in a high resolution format; identifying a reduced resolution format to be used; processing the high resolution media files to produce reduced resolution media files in accordance with the reduced resolution format; and storing the reduced resolution media files to the first removable data storage card or a second data storage card, whereby the storage space consumed by the reduced resolution media files is substantially less than the storage space consumed by the high resolution media files.

As a computer readable medium including at least computer program code for reducing resolution of media items, one embodiment of the invention includes at least: computer program code for reading high resolution media files from a first removable media storage card, the first removable data storage card having the high resolution media files pertaining to media items stored thereon in a high resolution format; computer program code for identifying a reduced resolution format to be used; computer program code for processing the high resolution media files to produce reduced resolution media files in accordance with the reduced resolution format; and computer program code for storing the reduced resolution media files to the first removable data storage card or a second data storage card, whereby the storage space consumed by the reduced resolution media files is substantially less than the storage space consumed by the high resolution media files.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is an overview diagram of a media presentation system according to one embodiment of the invention.

FIG. 2 is a block diagram of a digital media viewer according to one embodiment of the invention.

FIG. 3 illustrates modules of program code according to one embodiment of the invention.

FIG. 4A is a flow diagram of a resolution reduction process according to one embodiment of the invention.

FIG. 4B is a data flow diagram of another resolution reduction process according to one embodiment of the invention.

FIG. 5 is a flow diagram of an image archive process according to one embodiment of the invention.

FIG. 6 is a flow diagram of a media presentation process according to one embodiment of the invention.

### DETAILED DESCRIPTION OF THE INVENTION

The invention pertains to a digital media player. The digital media player can permit one or a group of users to play digital media in a convenient and user-friendly manner. Typically, a memory card stores the digital media to be played by the digital media player. After the memory card is coupled to the digital media player, the digital media player can operate to play (e.g., view) or manipulate (e.g., zoom, rotate, delete, etc.) the digital media. The digital media player can also operate to archive digital media in a reduced resolution format. The reduced resolution format is adequate for an intended output device, yet has a substantially reduced file size.

As used herein, a memory card includes card-like configurations (including memory sticks). The digital media stored to the memory card and made available to a digital media viewer can pertain to one or more media items. The media items can, for example, pertain to images (e.g., photos), audio or videos.

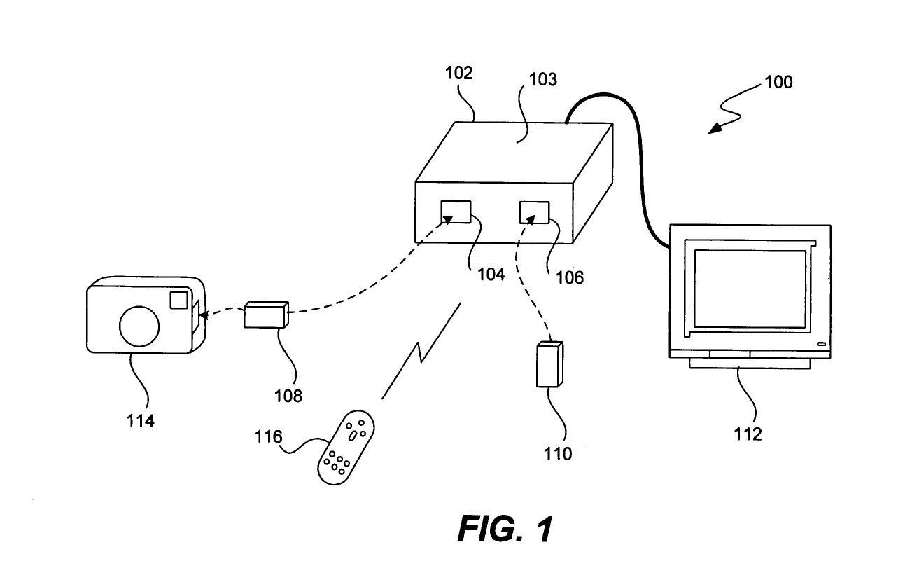

Embodiments of this aspect of the invention are discussed below with reference to FIGS. 1-6. However, those skilled in the art will readily appreciate that the detailed description given herein with respect to these figures is for explanatory purposes as the invention extends beyond these limited embodiments.

FIG. 1 is an overview diagram of a media presentation system 100 according to one embodiment of the invention. The media presentation system 100 includes a digital media viewer 102. The digital media viewer 102 has a housing 103. The housing 103 has a first slot 104 and a second slot 106 that are each capable of receiving data storage cards. For example, as shown in FIG. 1, the first slot 104 can receive a first removable data storage card 108, and the second slot 106 can receive a second removable data storage card 110. The first removable data storage card 108 and/or the second removable data storage card 110 are used to store media items, namely, media files for the media items. More generally, the housing 103 can provide one or more slots, and each slot can accept one or more different card formats.

In one implementation, the media items are images (i.e., photos) contained in image files. The digital media viewer 102 can read the image files from either or both of the first removable data storage card 108 and the second removable data storage card 110, and then present the one or more images on a display device 112. For example, the display device 112 can be a television set or a Liquid Crystal Display (LCD) projector.

As shown in FIG. 1, a camera 114 can be used to capture image files pertaining to images (i.e., photos) and store them to the first removable data storage card 108 while the first removable data storage card 108 is inserted into a slot of the camera 114. Then, when the user desires to view the resulting photos that have been captured using the camera 114, the first removable data storage card 108 is removed from the slot of the camera 114 and inserted into the first slot 104 of the digital media viewer 102. Thereafter, assuming the digital media viewer 102 is powered-on and the second removable data storage card 110 is inserted into the second slot 106, the one or more image files stored to the first removable data storage card 108 can be read by the digital media viewer 102 and then converted to a reduced resolution format and stored on the second removable data storage card 110. In other words, the one or more images captured by the camera 114 and stored to the first removable data storage card 108 can be altered to a reduced resolution format and then stored to the second removable data storage card 110. In effect, the images are archived in a reduced resolution format on the second removable data storage card 110. As a result, the second removable data storage card 110 is able to store a large number of image files. As an example, the file size of a high resolution image is often 1 megabytes (MB) or more, while at the reduced resolution, the file size can be on the order of about 50 kilobytes (KB), which is at least twenty times smaller. At such a file size (i.e., 50 KB), a 64 MB removable data storage card could hold over twelve hundred (1200) photos. However, the file sizes of the reduced resolution images vary with the reduced resolution format. Hence, in different embodiments or configurations, the file size of the reduced resolution images can, for example, be at least five, ten or twenty times smaller.

Furthermore, the subsequent retrieval of the image files from the second removable data storage card 110 and the display of the reduced resolution format images therefrom is not detrimental because the reduced resolution is typically close to or greater than the maximum resolution supported by the display device 112. For example, in the case where the display device 112 is a standard television, then the reduced resolution format can use a VGA format representing 640×480 resolution. The typical corresponding resolution of a television broadcast frame is on the order of 528×576 (PAL) and 528×480 (NTSC). Hence, both the high resolution images and the low resolution images are effectively displayed in the same way on the display device 112. However, due to their smaller file size, the low resolution images can be loaded (and displayed) much faster than the high resolution images.

The media presentation system 100 can also use a remote controller 116 to interact with the digital media viewer 102. Through user interaction with the remote controller 116, the user can request the digital media viewer 102 to store files containing reduced resolution media items (e.g., images) to either the first removable data storage card 108 or the second removable data storage card 110. Further, the user of the remote controller 116 could also interact with the digital media viewer 102 to cause the images (i.e., photos) to be displayed, and once displayed, the user can navigate the display of particular images and cause the images to be edited, rotated, zoomed (in or out), deleted, etc.

In FIG. 1, the first slot 104 and the second slot 106 were provided on a common surface of the housing 103 associated with the digital media viewer 102. However, it should be noted that the second slot 106 (which typically receives the removable data storage card 110 to receive the reduced resolution formatted media items) can be provided in a less conspicuous part of the housing of the digital media viewer 102. For example, the second slot 106 could be placed at a back, rear, side or non-exposed surface of the housing of the digital media viewer 102. In this regard, the second slot 106 holds the removable data storage card 110 that is to hold a large number of media items (e.g., images) in an archive-type fashion so that they can be viewed on the display device 112. It is envisioned that in some cases, the removable data storage card be would normally maintained (i.e., retained) within the second slot so as to provide resident archive storage.

Still further, the data storage to hold the media items with the reduced resolution could alternatively be non-removable data storage of the digital media viewer 102. The non-removable data storage could be data storage provided internal to the housing 103. For example, the data storage could be a non-volatile memory (e.g., FLASH memory) internal to the housing 103.

As previously noted, memory cards can have a relatively small form factor and can be used to store digital data for electronics products such as cameras, hand-held or notebook computers, network cards, network appliances, set-top boxes, hand-held or other small audio players/recorders (e.g., MP3 devices), and medical monitors. Examples of a memory card include PC Card (formerly PCMCIA device), Flash card (e.g., Compact Flash Type I and II), Secure Digital (SD) card, Multimedia card (MMC), ATA card (e.g., Compact Flash card), memory stick, SmartMedia card, and x-D-Picture card. As an example, the memory card can use Flash-type or EEPROM-type memory cells to store the data.

In one embodiment, the remote controller 116 for the digital media viewer 102 can include a dedicated button (e.g., STORE button) on the remote control for archiving an image. When a high resolution image is displayed or a thumbnail or image file name is (pre)selected (e.g., highlighted in the screen), and the user presses on the STORE button on the remote controller (or the digital media player itself or as an on-screen menu option), the high resolution image will be loaded in memory (e.g., RAM) if not done so yet and will be resized according to resize/storage settings. Thereafter, the reduced resolution image will be stored according to storage settings (e.g., destination memory card (card slot) or embedded memory), (sub)folder location and file name). For example, if the destination is the memory card inserted in a back slot of the digital media viewer, a folder can be named or specify the date of when the image was made (e.g., retrieved from a timestamp in the image file) and the name is the time the image was made. As an example, an image can be stored with the name “<hour>:<minute>” (e.g., 14:49 or 2:49 pm) in folder <month><day><year> (e.g., Jul. 11 2003). Such a folder can be created on the fly on the memory card to receive the processed image(s). Afterwards the user can rename and re-organize the images through the user interface and buttons on the remote controller or digital media viewer itself.

Additional embodiments of a digital media viewer can also facilitate other features. One other feature is the ability of a digital camera to be connected to and interact with the digital media viewer. Here, large image files captured by the digital camera can be resized to smaller versions. In such an embodiment, the digital media player has a data port (and perhaps host functionality) so that a data connection can be made with the digital camera. For example, the data port could be over FireWire, USB, serial port, etc. By connecting the digital camera and a display device to the digital media player, the user can access the images stored in the digital camera and have them resized through the digital media player. In effect, the digital camera can be treated as if it is a card in an external slot of the digital media player. The resized images can be stored on one of the cards inserted in the digital media player or on embedded memory within the digital media player. Alternatively, the resized images can be stored to the memory card or embedded memory of the digital camera. In this case, the digital media player can be a dedicated ‘resize’ device that does not have any slots for memory cards and need not have embedded memory. Alternatively, the digital media player may have only embedded memory and no card slots as the images are accessed by connecting the digital camera directly to the digital media player. Here, the digital media player can be acting as a docking station with a dedicated connection for data transfer and power to recharge the batteries and the digital camera during interaction with the digital media player.

In any of the above embodiments, a user can store files on the source card/embedded memory which replace the original files or are new resized files.

Another feature of the digital media viewer is that it need not connect to a separate display device such as a television. The digital media player might include its own display device (e.g., LCD screen). Alternatively, the remote controller might include a display screen.

With the buttons on the player and/or on the remote control, the user can access the files (containing images, video clips, audio files) and operate the digital media player in order to present the content on a display device, such as a television or a projector, or audio system. For the functionality mentioned above pertaining to resizing images directly from memory in digital cameras, if the digital media player has a LCD screen, it is not necessary to connect the digital media player to a television. The digital media player can thus be battery-operated or get its power through a data port, such as USB or FireWire.

Another feature is that the digital media player can connect with a personal computer, such as via a data port. The PC can obtain the archived images from a memory card (archive card) inserted into the digital media player and then store a copy the images on its storage drive (e.g., hard drive or CD drive) as a backup copy (in high or reduced resolution).

Yet another feature of the digital media viewer with multiple slots is that it facilitates copying media files from card to card. An operation can be performed to copy the contents of an entire card to another (independent from the content) by adding a ‘COPY’ button to the digital media player, its remote controller, or via an on-screen menu. For example, after pressing the ‘COPY’ button or selecting the function from the on-screen menu, the user can select the source slot/card, the destination slot/card and then start the process. As another example, when an image is displayed full screen, the user can select the individual image by pressing the ‘COPY’ button. A menu can then pop-up so that the user can select a destination card/slot (which can also be the embedded memory, if present, or a storage medium connected via the data connection).

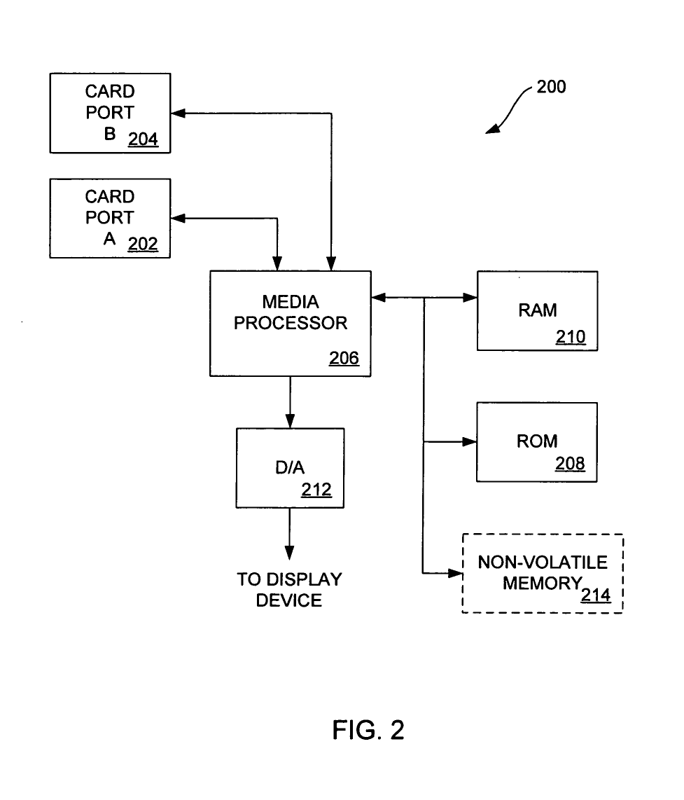

FIG. 2 is a block diagram of a digital media viewer 200 according to one embodiment of the invention. The digital media viewer 200 is, for example, one implementation suitable for use as the digital media viewer 102 illustrated in FIG. 1.

The digital media viewer 200 includes a first card port A 202 and a second card port B 204. The card port A 202 corresponds to the first slot 104 shown in FIG. 1, and the card port B 204 corresponds to the second slot 106 illustrated in FIG. 1. The digital media viewer 200 also includes a media processor 206, Read-Only Memory (ROM) 208, and Random-Access Memory (RAM) 210. The ROM 208 and the RAM 210 can be provided externally (as shown) or can be provided integral with the media processor 206. The ROM 208 typically stores program code that is executed by the media processor 206. The RAM 210 provides temporary data storage for the media processor 206. As discussed in greater detail below, the media processor 206 can receive media files from either of the card ports 202 and 204 and output digital video signals to a digital-to-analog converter 212. The output of the digital-to-analog converter 212 is audio/video signals that are provided to a display device, such as the display device 112 shown in FIG. 1. The audio/video signals can use any of a number of different formats (e.g., S-Video, component video and CVBS).

Additionally, the media processor 206 can convert high resolution media files into reduced resolution media files. Typically, the media processor 206 would read high resolution media items from a data storage card coupled to either the card port A 202 or the card port B 204, process the media items into reduced resolution media items, and then store the reduced resolution media items back to either the card port A 202 or the card port B 204. Alternatively, the digital media viewer 200 can include an internal non-volatile memory 214 where the reduced resolution media items can be stored.

Hence, under the control of the media processor 206, the digital media viewer 200 performs operations to effectuate resolution reduction and media presentation. In this regard, the media processor 206 executes program code that can be considered to correspond to resolution reduction and media presentation. The media processor 206 can be a graphics processor but, in other embodiments, can be a multimedia or audio/video processor.

Although the digital media viewer 200 shown in FIG. 2 includes the digital-to-analog converter 212, in an alternative embodiment, the digital media viewer can output digital video to a display device. The digital video output can be supplied to the display device over any of a number of different connections, such as FireWire, USB, DVI, SPDIF (optical). In such a case, the digital media viewer would not need a digital-to-analog converter to produce audio/video signals for the display device.

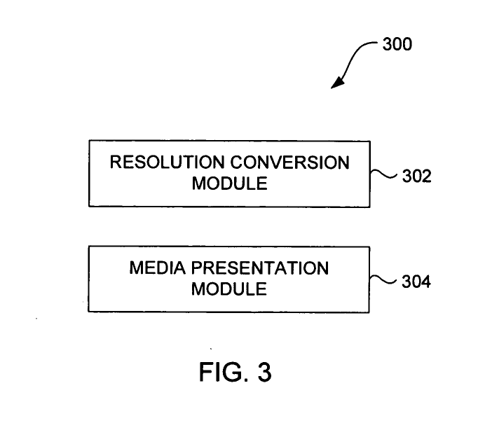

FIG. 3 illustrates modules of program code according to one embodiment of the invention. The program code 300, according to one embodiment, includes a resolution conversion module 302 and a media presentation module 304. The resolution conversion module 302 pertains to program code that is utilized by the media processor 206 when reducing resolution of one or more media items (e.g., image files). The media presentation module 304 represents program code utilized by the media processor 206 to display media (e.g., images) on the display device.

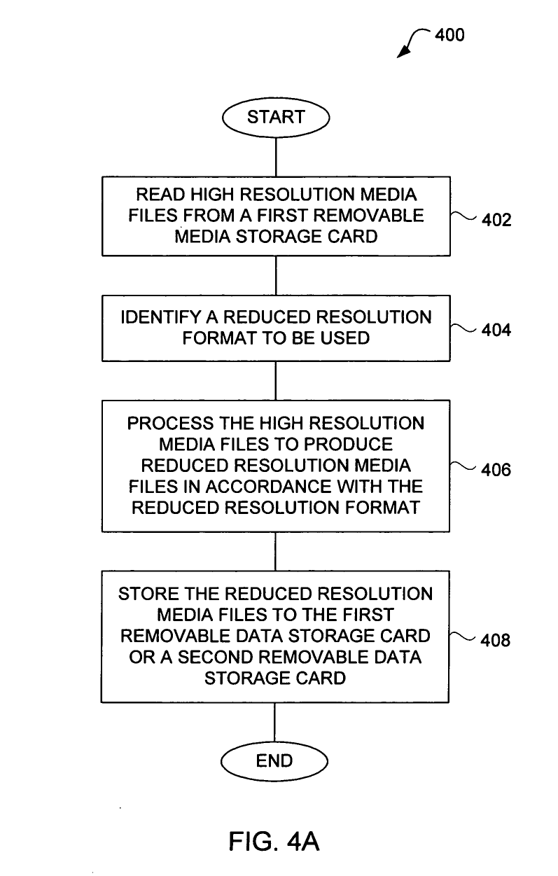

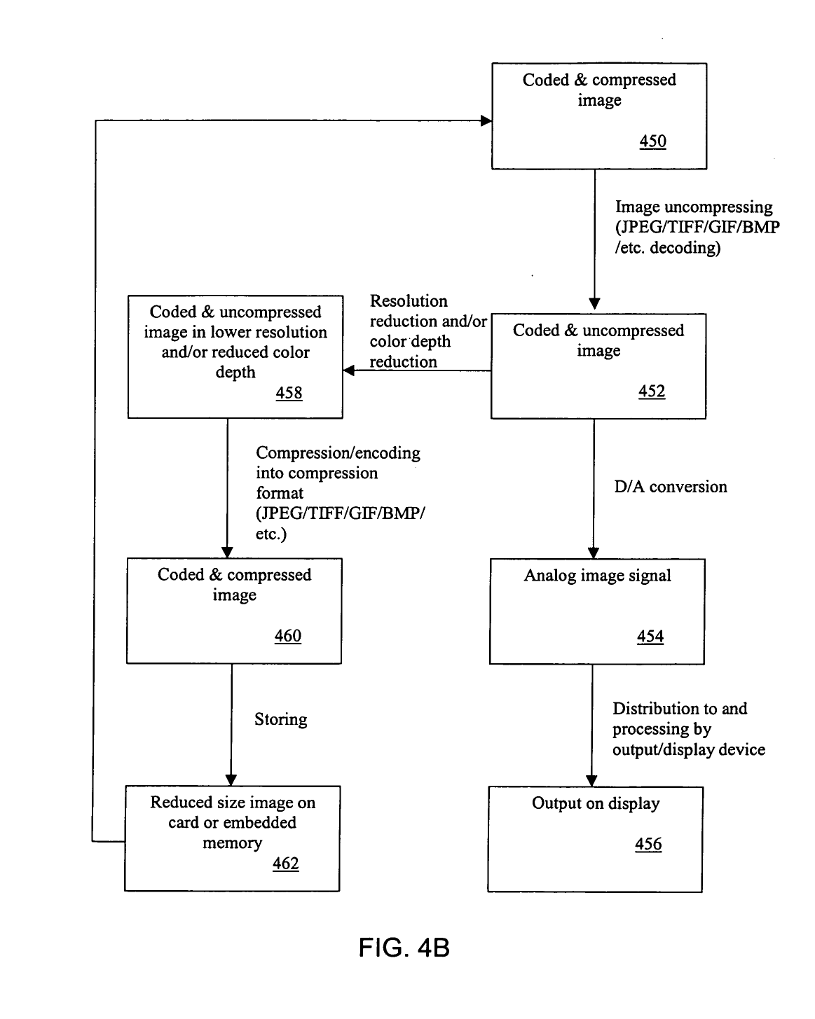

FIG. 4A is a flow diagram of a resolution reduction process 400 according to one embodiment of the invention. The resolution reduction process 400 is, for example, processing associated with the resolution conversion module 302 or, more generally, processing carried out by the media processor 206 illustrated in FIG. 2.

The resolution reduction process 400 initially reads 402 high resolution media files from a first removable media storage card. Then, a reduced resolution format to be used is identified 404. Here, the reduced resolution format can be provided by a user selection, a user setting, or a default.

The user can select from various different resolutions for the reduced resolution format, such as 320×240, 640×480, 800×600, 1024×768, 1280×720, or 1920×1080. Additionally, the resolution selection can specify an estimate on the impact to file size or storage capacity in terms of media items, such as ten images per megabyte or twelve hundred (1200) images per memory card, so as to guide the user.

If there is no user selection, then user settings can be used to choose the resolution. If there is no user selection or user setting for the resolution, then a default resolution can be utilized.

Next, the high resolution media files are processed 406 to produce reduced resolution media files in accordance with the reduced resolution format. For example, a high resolution media file might be on the order of 2048×1536 resolution, which would be representative of a photograph taken by a 3.1 megapixel camera. The reduced resolution format could be a VGA format, such as 640×480 resolution. Hence, by making the resolution conversion, the size of the media file is drastically reduced by about twenty times. Thereafter, the reduced resolution media files are stored 408 to the first removable data storage card or a second removable data storage card. Following the block 408, the resolution reduction process 400 is complete and ends.

In an alternative embodiment, the size of the media files can be further reduced by providing an option to select or impose a reduced compression ratio and/or a reduced color depth. Although the reduced compression ratio and/or the reduced color depth can be used in conjunction with reduced resolution, it should be understood that these techniques can also be separately imposed.

In another alternative embodiment, the reduced resolution media files can be stored 408 to a non-volatile data storage device. The non-volatile data storage device can be the first removable data storage card, the second removable data storage card, or a memory chip internal to a digital media viewer.

FIG. 4B is a data flow diagram of another resolution reduction process according to one embodiment of the invention. The data flow process beings with a coded and compressed image 450. The coded and compressed image is uncompressed to obtain a coded and uncompressed image 452. Then, following a digital-to-analog conversion, an analog image signal 454 results. The analog image signal 454 can then be output to a display 456. Alternatively, when the image is to be resized and stored, the coded and uncompressed image is reduced in resolution and/or color depth 458. The reduced resolution/color depth image is then compressed/encoded to yield a coded and compressed image 460. The coded and compressed image 460 is a reduced size image which can be stored 462 on a memory card or embedded memory. Subsequently, after the reduced size image is stored 462, the blocks 450456 can cause the image to be displayed.

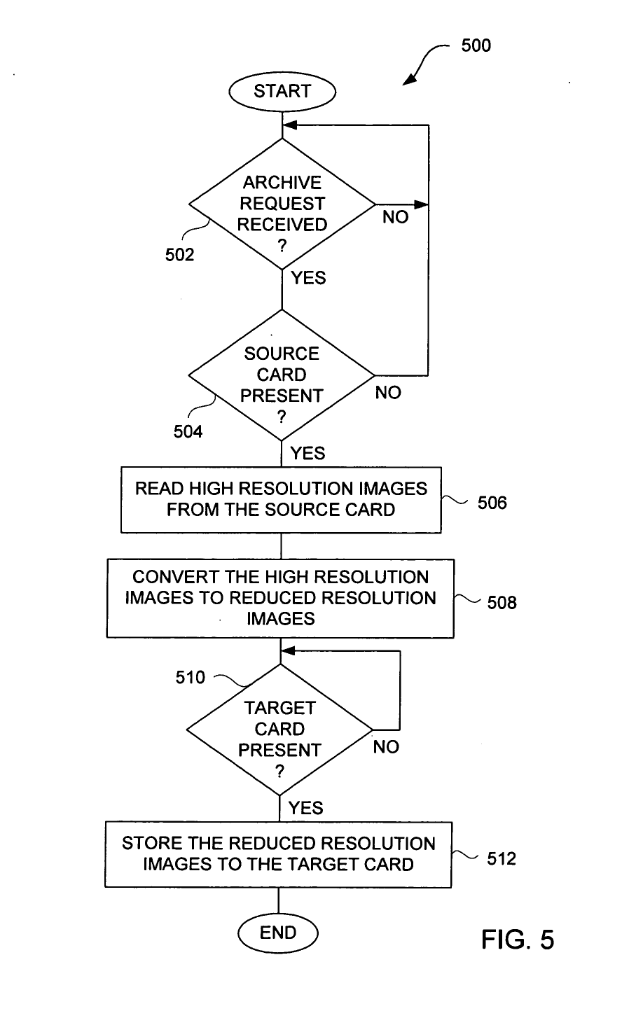

FIG. 5 is a flow diagram of an image archive process 500 according to one embodiment of the invention. The image archive process 500 is, for example, processing associated with the resolution conversion module 302 and/or the media processor 206.

The image archive process 500 begins with a decision 502 that determines whether an archive request has been received. The archive request would be provided by a user that is desirous of archiving images onto a removable data storage card. When the decision 502 determines that an archive request has not been received, then the image archive process 500 simply awaits such a request.

Once the decision 502 determines that an archive request has been received, a decision 504 determines whether a source card is present. Here, the archive request would specify implicitly or explicitly a source card, a target card and a target resolution. When the decision 504 determines that a source card is not present, then the image archive process 500 returns to repeat the decision 502 since processing cannot be performed until the source card having the high resolution images is available. On the other hand, when the decision 504 determines that the source card is present, then the high resolution images from the source card are read 506. Next, the high resolution images are converted 508 to reduced resolution images. Here, the conversion to the reduced resolution images is based on the target resolution that is provided with the archive request.

Following the block 508, a decision 510 determines whether a target card is present. The target card is the removable data storage card that is to store the reduced resolution images. Hence, the decision 510 determines whether the target card is available to have the reduced resolution images stored thereon. When the decision 510 determines that the target card is not present, then the image archive process 500 awaits its arrival. If desired, the image archive process 500 could additionally prompt the user to insert the target card so as to make it available. On the other hand, when the decision 510 determines that the target card is present, then the reduced resolution images are stored 512 to the target card. Following the block 512, the image archive process 500 is complete with the image files being archived on the target card.

In an alternative embodiment, the archive request need not specify a target resolution, but instead specify a display or presentation device. In such a situation, the target resolution can be determined based on the maximum resolution of the display or presentation device selected.

The target card can be a dedicated memory card. For example, such a dedicated memory card could be user-accessible at a separate slot that is different from other slots, such as at the back, rear or side of the housing of a digital media viewer. However, the target card could also be the source card, another memory card at a standard slot, or a non-volatile (e.g., FLASH) memory chip embedded within a digital photo viewer. The images can be in various formats, such as JPEG, GIF, TIFF, PNG, RAW, and BMP. Typically, a default format can be utilized, though the user would be able to select different formats if desired.

The media items can be archived onto the target card per selection, per directory, or per card. In one embodiment, when the media items are stored to the target card, the media items can be placed into directories. These archive directories can have default names based on the date, picture number or user input. The archive directories can also be represented by a thumbnail image pertaining to one of the images (i.e., photos) in the directory.

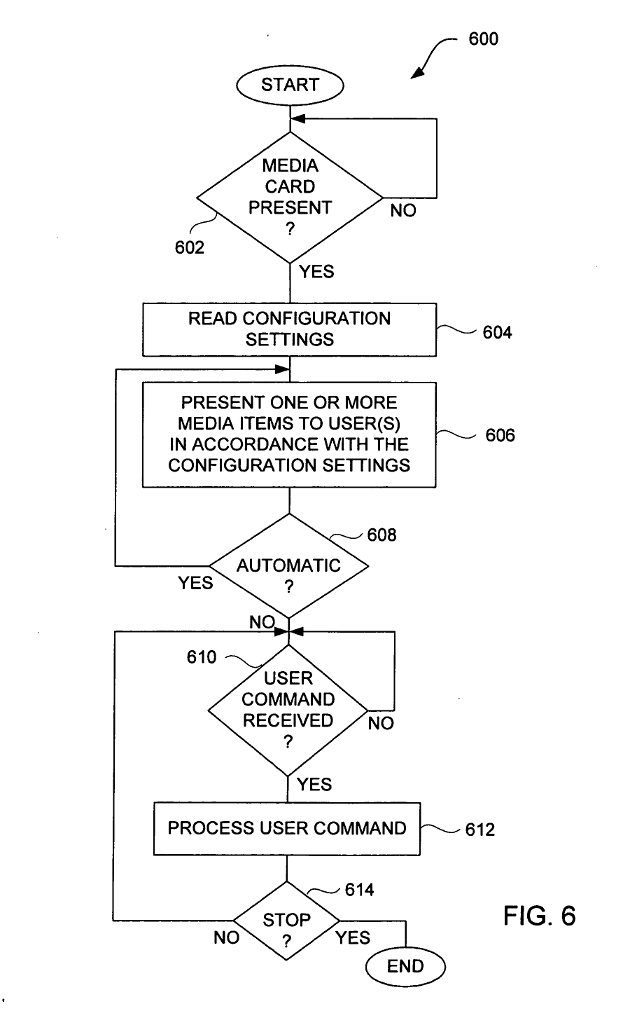

FIG. 6 is a flow diagram of a media presentation process 600 according to one embodiment of the invention. The media presentation process 600 is, for example, processing associated with the media presentation module 304 illustrated in FIG. 3 and/or processing carried out by the media processor 206 illustrated in FIG. 2.

The media presentation process 600 begins with a decision 602 that determines whether a media card is present. Here, it is assumed that the media card stores image files that are to be displayed by a digital media viewer, such as the digital media viewer 102 illustrated in FIG. 1. Hence, it is assumed that the media card stores media files for media items (e.g., images) that are to be presented (e.g., displayed) by the digital media viewer.

When the decision 602 determines that a media card is present, then configuration settings are read 604. The configuration settings are associated with the digital media viewer that is performing the media presentation process 600. The configuration settings can, for example, indicate the order, sequencing and manner in which the media items (e.g., images) stored to the media card are to be presented (i.e., displayed). Next, one or more media items are presented 606 to the one or more users in accordance with the configuration settings.

A decision 608 determines whether the presentation is automatic or manual. When the decision 608 determines that the presentation is automatic, then the media presentation process 600 can return to repeat the block 606 so that the sequencing (e.g., slide slow) of the media items can be automatically achieved without user interaction. On the other hand, when the decision 608 determines that the presentation is not automatic, a decision 610 determines whether a user command has been received. When the decision 610 determines that a user command has not yet been received, the media presentation process 600 awaits such a command. Alternatively, when the decision 610 determines that a user command has been received, then the user command is processed 612. The user command can select another media item or can initiate other operations, such as rotate, zoom, delete, etc.

Next, a decision 614 determines whether the media presentation process 600 should stop. When the decision 614 determines that the media presentation process 600 should not stop, then the media presentation process 600 returns to repeat the decision 610 so that subsequent user commands can be received and processed. Alternatively, when the decision 614 determines that the media presentation process 600 should stop, then the media presentation process 600 ends.

A digital media player according to the invention can also play audio files (e.g., MP3, .WAV, MC, WMA, OGG, and MP3 Pro) files that are stored on a removable data storage card. The archiving process would not impact these files but store them to the archive storage device. Still further it should be understood that the audio files can be played while media items are presented (e.g., displayed) for users. The digital media player can include its own speaker for audio output or can use the speaker of a connected media device, such as a television. The audio files can be played in a continuous loop for stop after stop after playing them once. The media items being presented (e.g., images and/or video) can also play in a continuous loop or stop after being played once.

The digital media player can permit linking of audio files to individual images or to a slide show. The user could select an image via the on-screen user interface and also select an audio file (e.g., music) from the same or another card (or from embedded memory of the digital media player). The link between the image and the audio file can then be made. Thereafter, when the image is displayed by the digital media player, the associated audio from the audio file starts to play. With player settings, the user can select whether the image is displayed during the length of the audio or whether the audio plays as long as the image is shown. Another option is to have a slide show runs as long as the length of the audio (e.g., the display interval time for each slide is the length of the audio file divided by the number of slides). Furthermore, the user can select a series of audio files to be entered into a playlist. This playlist can be linked to a slide show. Also, the user can select how the audio and slides are to be synchronized. For example, the display interval time for each slide can be is the duration of the playlist divided by the number of slides in the slide show. As another example, the display interval time can be fixed and if the duration of the playlist is less than the slide show duration, the playlist can run in a loop. In yet another example, each slide of the slide show can remain displayed for the duration of an audio file.

In one embodiment, audio files can be link to images or slide shows by folders. For example, if the memory card stores folders that contain images and one or more audio files, then when an image is displayed or a slide show started, the digital media player can check the folder for compatible audio files. If one or more audio files are detected, they can be played while the image is displayed or the slide show is being played. The audio file(s) can be played in accordance with various options, e.g., user settings, as noted above. The play order of the audio files can also be determined by the user, determined by order stored (e.g., alphabetically), random or repeat. In another embodiment, the digital media player can be configured to check a designated card slot for audio files when an image is displayed or slide show starts.

Still another feature that the digital media player can have is a ‘RECORD’ button on the digital media player or a remote controller. When the user presses the ‘RECORD’ button and speaks into a microphone integrated in the media player device, an audio file is created and stored to an inserted card or embedded memory. In this regard, the user can record comments that pertain to an image. As with the music, these kind of audio files can be linked to images or slide shows.

The advantages of the invention are numerous. Different embodiments or implementations may yield one or more of the following advantages. One advantage of the invention is that digital media can be easily and conveniently displayed by an output device, such as a television. Another advantage of the invention is that substantially greater numbers of media items (e.g., photos) can be stored to a memory card.

The many features and advantages of the present invention are apparent from the written description and, thus, it is intended by the appended claims to cover all such features and advantages of the invention. Further, since numerous modifications and changes will readily occur to those skilled in the art, it is not desired to limit the invention to the exact construction and operation as illustrated and described. Hence, all suitable modifications and equivalents may be resorted to as falling within the scope of the invention.

1. A digital media viewer, comprising:
a housing having a plurality of slots for receiving at least one removable storage card, the at least one removable storage card storing digital media items; and
a processor operable to access the digital media items from the at least one removable storage card, modify the digital media items to have a reduced resolution format, and store the modified digital media items having the reduced resolution format to the at least one removable storage card or another storage card.

2. A digital media viewer as recited in claim 1, wherein the digital media items are digital images.

3. A digital media viewer as recited in claim 2, wherein the digital media items were previously stored to the at least one removable storage card by a camera.

4. A digital media viewer as recited in claim 1, wherein the at least one removable storage card provides non-volatile semiconductor data storage.

5. A digital media viewer as recited in claim 1, wherein the at least one removable storage card is a FLASH data storage card.

6. A digital media viewer as recited in claim 1, wherein the at least one removable storage card is a memory card.

7. A digital media viewer as recited in claim 1, wherein the reduced resolution format is user-determinable.

8. A digital media viewer as recited in claim 1, wherein the reduced resolution format is substantially a VGA format.

9. A digital media viewer as recited in claim 1, wherein said digital media viewer further comprises a video output port for supplying video signals to a display device so that the modified digital media items can be displayed.

10. A digital media viewer as recited in claim 1, wherein the reduced resolution format is associated with a resolution of an Intended display device.

11. A digital media viewer as recited in claim 1,
wherein said processor accesses the digital media items or the modified digital media items and then produces digital video output, and
wherein said digital media viewer further comprises:
a digital-to-analog converter operatively connected to receive the digital video output and to produce analog video display signals; and
a video output port that outputs the analog video display signals.

12. A digital media viewer as recited in claim 11, wherein the video display signals being output are supplied to a television that displays the digital media items or the modified digital media items.

13. A digital media viewer as recited in claim 1, wherein said processor accesses the digital media items or the modified digital media items and then produces digital video output.

14. A digital media viewer as recited in claim 11, wherein the video display signals being output are supplied to a display device.

15. A dedicated digital media player, comprising:
a housing having a plurality of slots for receiving at least one removable storage card, the at least one removable storage card storing digital media items; and
a processor operable to access the digital media items from the at least one removable storage card, and to produce output signals for presenting the digital media items to one or more interested persons.

16. A dedicated digital media player as recited in claim 15, wherein at least one of the slots of said housing accepts removable storage cards having different formats.

17. A dedicated digital media player as recited in claim 15, wherein the output signals are analog video signals.

18. A dedicated digital media player as recited in claim 15,
wherein said processor accesses the digital media items and then produces digital video output, and
wherein said digital media player further comprises:
a digital-to-analog converter operatively connected to receive the digital video output and to produce analog video display signals; and
a video output port that outputs the analog video display signals.

19. A dedicated digital media player as recited in claim 18, wherein the video display signals being output are supplied to a television that displays the digital media items.

20. A dedicated digital media player as recited in claim 15, wherein said processor further modifies the digital media items to have a reduced resolution format.

21. A dedicated digital media player as recited in claim 20, wherein said processor further stores the modified digital media items having the reduced resolution format to the at least one removable storage card or another card.

22. A digital media player as recited in claim 15,
wherein the at least one removable storage card provides non-volatile semiconductor data storage, and
wherein the slots support a plurality of different storage card formats.

23. A digital media player as recited in claim 15, wherein said digital media player further supports wireless interaction with a remote controller.

24. A method for reducing resolution of media items to be commensurate with a display device for viewing media items, said method comprising:
reading high resolution media files from a first removable media storage card, the first removable data storage card having the high resolution media files pertaining to media items stored thereon in a high resolution format;
identifying a reduced resolution format to be used;
processing the high resolution media files to produce reduced resolution media files in accordance with the reduced resolution format; and
storing the reduced resolution media files to the first removable data storage card or a second data storage card, whereby the storage space consumed by the reduced resolution media files is substantially less than the storage space consumed by the high resolution media files.

25. A method as recited in claim 24, wherein the storage space consumed by the reduced resolution media files is at least one-fifth that of the storage space consumed by the high resolution media files.

26. A method as recited in claim 24, wherein the storage space consumed by the reduced resolution media files is at least one-tenth that of the storage space consumed by the high resolution media files.

27. A method as recited in claim 24, wherein the storage space consumed by the reduced resolution media files is at least one-twentieth that of the storage space consumed by the high resolution media files.

28. A method as recited in claim 24, wherein the reduced resolution format is approximately commensurate with the maximum resolution supported by the display device.

29. A method as recited in claim 24, wherein said identifying comprises:
determining whether a user-specified resolution has been set; and
selecting the user-specified resolution as the reduced resolution format when said determining determines that a user-specified resolution has been set.

30. A method as recited in claim 29, wherein said identifying further comprises:
selecting a default resolution as the reduced resolution format when said determining determines that a user-specified resolution has not been set.

31. A method as recited in claim 24, wherein the high resolution media files and the reduced resolution media files are digital files pertaining to images.

32. A method as recited in claim 24, wherein the reduced resolution format is approximately commensurate with VGA resolution.

33. A method as recited in claim 24, wherein the reduced resolution format is approximately commensurate with 640×480 resolution.

34. A method as recited in claim 24, wherein said storing of the reduced resolution media files stores an archival copy of the high resolution media files in the reduced resolution format on the second data storage card which serves as a archival card.

35. A method as recited in claim 34, wherein the second data storage card is a removable data storage card.

36. A method as recited in claim 24, wherein the second data storage card is a removable data storage card.

37. A computer readable medium including at least computer program code for reducing resolution of media items, said computer readable medium comprising:
computer program code for reading high resolution media files from a first removable media storage card, the first removable data storage card having the high resolution media files pertaining to media items stored thereon in a high resolution format;
computer program code for identifying a reduced resolution format to be used;
computer program code for processing the high resolution media files to produce reduced resolution media files in accordance with the reduced resolution format; and
computer program code for storing the reduced resolution media files to the first removable data storage card or a second data storage card, whereby the storage space consumed by the reduced resolution media files is substantially less than the storage space consumed by the high resolution media files.

38. A computer readable medium as recited in claim 37, wherein the media items are images.
